(19) United States
(12) Patent Application Publication
(10) Pub. No.: US 2009/0047082 A1
(43) Pub. Date: Feb. 19, 2009

(54) Novel composite compositions and new and novel machine and contact tools

(76) Inventor: Gregory James Kay, Midland, MI (US)

Correspondence Address: MCKELLAR IP LAW, PLLC, 784 SOUTH POSEYVILLE ROAD, MIDLAND, MI, 48640, US

(21) Appl. No.: 12/228,195

(22) Filed: Aug. 12, 2008

Related U.S. Application Data
(60) Provisional application No. 60/964,892, filed on Aug. 15, 2007.

(51) Int. Cl. B23B 27/14

(52) U.S. Cl. 408/144; 523/200; 977/742

(57) ABSTRACT

Composite compositions and machine and contact tools, for example, metal boring tools and face mills that are manufactured from them. The tools are provided with composite structure to lighten the tools and yet retain the strength and durability of the tool. The novelty resides in the use of additives to certain fiber composite materials in the composites that make up a portion of the tool, especially tool bars.

This application claims priority from U.S. Provisional Patent Application No. 60/964,892, filed Aug. 15, 2007.

### BACKGROUND OF THE INVENTION

This invention deals with new and novel composite compositions and machine and contact tools, for example, metal boring tools and face mills that are manufactured from them. The tools are provided with composite structure to lighten the tools and yet retain the strength and durability of the tool. The novelty resides in the use of additives to certain fiber composite materials in the composites that make up a portion of the tool, especially tool bars.

Tool bars for use in mounting cutting tools such as most conventional boring and reaming bars are manufactured to be elongate and thin in order to machine a deep hole in a work product.

Being long and thin often leads to a bendable tool which is not easily tolerated in the industry as it creates low quality products. This bendability and lack of stiffness in the tool leads to chattering and in order to reduce this chattering, the speed of the boring tool is lessened and the feed rates are thus low, leading to low production rates. This problem has plagued the industry for a long time, and many approaches have been taken to provide tools that have high stiffness, less bendability, increased dampening, and decreased weight.

For example, various shapes of cutting tools and tool bars for use in mounting the cutting tools have been developed. Many other tool bars for use in mounting cutting tools, which are made of tungsten carbide alloy and tool steel having very excellent stiffness and rigidity characteristics, have been also developed in some countries.

However, since it is difficult to machine cemented carbide, there is a disadvantage, in that, manufacturing costs of a tool bar exhibiting optimum performance become very high. Further, since the natural frequency of a boring or reaming bar is low due to high densities of tungsten carbide and tool steel, there is a limitation on improvement of the cutting speed of the bar to remove metal and create a satisfactory finish. High weight causes several issues such as chatter, ease of use, release of the tool bars from the holder or adapter due to bending owing to the weight of the bar.

In addition, other tools, such as face mills are constructed to be heavy and durable so that they stand up to rigorous high stock removal and it would be advantageous to have such tools that could avoid or substantially avoid such adverse conditions, especially high temperature.

Fiber reinforced composites have an advantage over conventional materials in many applications because of their favorable strength to weight ratios, corrosion resistance, and unique stress coupling properties.

The method of manufacture is important in these fiber reinforced composites. The fiber orientation angle in each stiffness layer is alternated several times along the length of the component, internally, or in combination. Each time the fiber orientation angle is altered, a region of high shear is generated across the damping layer. By controlling the orientation angle, thickness, segment lengths and moduli, significant shearing occurs throughout the viscoelastic layer. Also, since the primary load path through the part is in the composite stiffness layers, the part retains high stiffness.

There are several patents dealing with cutting tools that are manufactured from tool bodies using composites. Once such device in which the body is manufactured from a carbon fiber composite in a curable epoxy resin can be found in U.S. Pat. No. 6,935,816, that issued on Aug. 30, 2005 which is incorporated herein for what it teaches about tool bars and their construction.

It has been discovered by the inventor herein that a portion of the tool can be constructed with the novel materials of this invention in order to reduce their weight yet retain their valuable properties such as strength and low chattering, that is, less or no vibration. This is especially valuable in tool bars.

### SUMMARY OF THE INVENTION

What is disclosed and claimed herein is in one embodiment, a composite composition, said composition comprising a fiber reinforced curable polymer and at least one additive material selected from the group consisting of nanodiamond, Buckminsterfullerene in the form of paper (bucky paper) prepared from carbon nanotubes and balls (bucky balls) prepared from carbon nanotubes, pitch fibers, pitch nanofibers, polyvinyl alcohol fibers, poly-paraphenylene terephthalamide (Kevlar®) having a physical form selected from the group consisting of films, fibers, and particulates, and PAN fibers. Also contemplated within the scope of this invention is the use of fiber reinforced curable polymers wherein the fibers are, in addition to those used as additives in this composition, selected from carbon, poly-paraphenylene terephthalamide, polyvinyl alcohol, pitch fibers, pitch nanofibers, PAN and the like.

One other embodiment of this invention is a composite tool body, the composite tool body formed from a composition comprising a fiber reinforced curable polymer and at least one additive material selected from the group set forth above.

In another embodiment, this invention comprises a high performance composite tool bar, the tool bar comprising a composite body having a first end and a second end. said first end being capable of having a cutting tool mounted thereon. The second end is capable of being mounted to a driving device. The composite body is constructed from a fiber reinforced curable polymer further containing at least one additive material selected from the group as set forth above.

A further embodiment of this invention is the use of a nanodiamond material that is further chemically modified at its surface.

Still further, another embodiment of this invention is a tool body that is a solid composite.

And, another embodiment of this invention is a composite tool body wherein the composite has a central metal core running through it.

Yet another embodiment of this invention is a composite tool body of this invention having a hollow core running through it.

Another embodiment of this invention is the use of tool bars that have squared, tapered, small radius step downs and tool bars that have surface posts.

Still another embodiment of this invention is a composite tool body of this invention having a metal sheath surrounding it.

A final embodiment of this invention are tool bars having removable heads and tails and mandrel stems as set forth in U.S. patent application Ser. No. 12/070,971, filed on Feb. 22, 2008 which is incorporated herein by reference for what it teaches about such tool bars and their construction and manufacture.

### BRIEF DESCRIPTION OF THE DRAWINGS

FIG. 1 is full side view of a composite tool body of this invention.

FIG. 2 is a full cross sectional view of the body of FIG. 1 through line A-A of FIG. 1.

FIG. 3 is a full side view of a high performance machine tool of this invention showing an adapter on the second end and a working tool on the opposite end and sheathed in a metal sheath wherein the cutting tool and the adapter are separated from the body for clarity.

FIG. 4 is a full side view of a cutting tool of this invention.

FIG. 5 is a full cross sectional view of the high performance machine tool of FIG. 3 through line B-B showing the cutting tool and the adapter.

FIG. 6 is a full cross sectional view of the high performance machine tool of FIG. 3 through line B-B also showing a metal bar in the core of the body.

FIG. 7 is a full side view of a tool bar of this invention showing a squared step down configuration.

FIG. 8 is a full side view of a tool bar of this invention showing a tapered step down configuration.

FIG. 9 is a full side view of a posted tool bar of this invention.

FIG. 10 is a full side view of a tool bar of this invention showing a small radius step down.

FIG. 11 is a full side view of a tool bar of this invention showing a channeled surface.

FIG. 12 is a full cross sectional end view of the tool bar of this invention through line 11-11 showing the channeled configuration of the bar.

FIG. 13 is a depiction of the configuration of FIG. 12, except in an eight point construction as opposed to the four point construction of FIG. 12.

FIG. 14 is a view in perspective of an end cap that is used over the end of the tool bar and is used for attaching a cutting head.

FIG. 15 is a full end view of a face mill tool of this invention showing the position of the composite in the interior of the face mill.

### DETAILED DESCRIPTION OF THE DRAWINGS

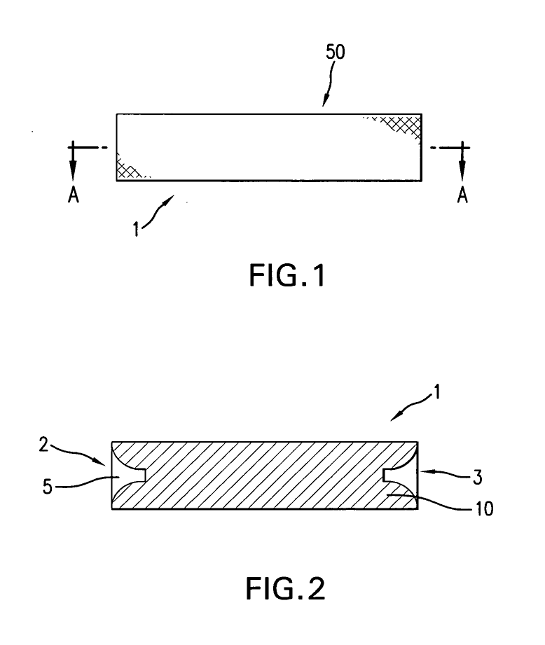

Turning now to FIG. 1, which is a full side view of a composite body 50 of this invention there is shown the wrapped composite 1 without any sheathing. FIG. 2 shows a full cross sectional view of the body 1 of FIG. 1 through line A-A.

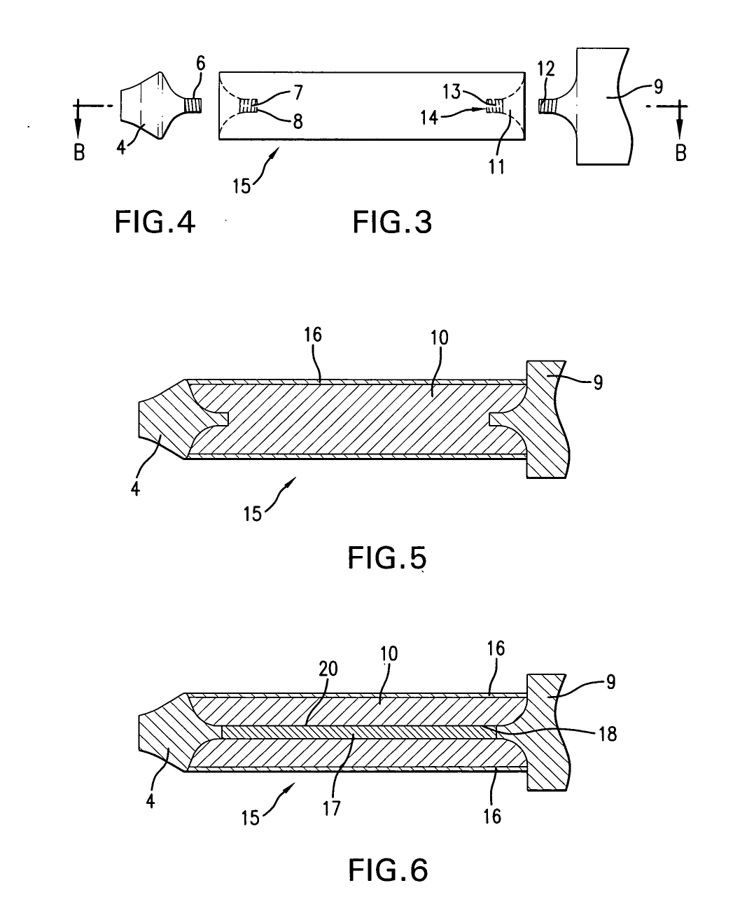

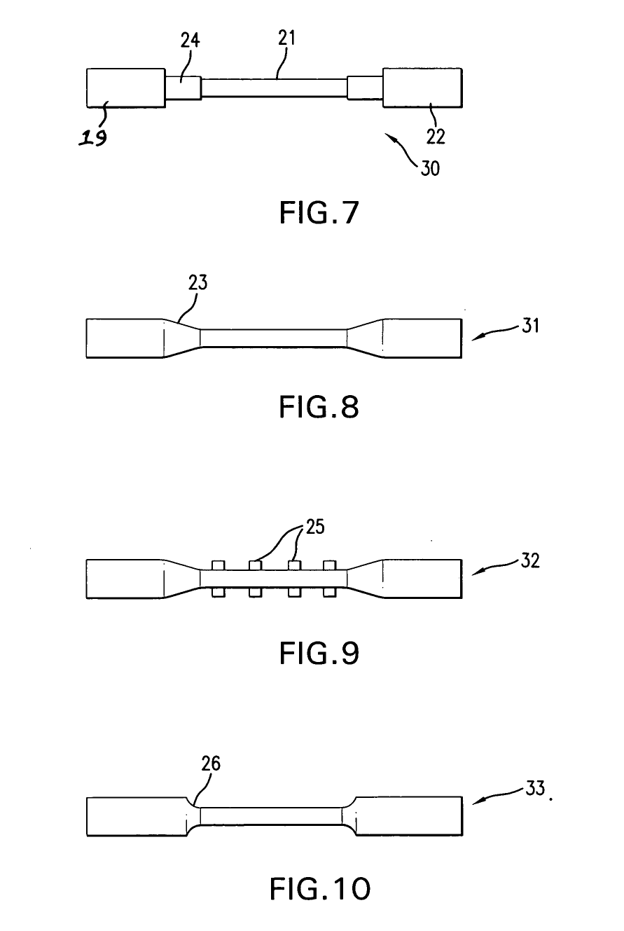

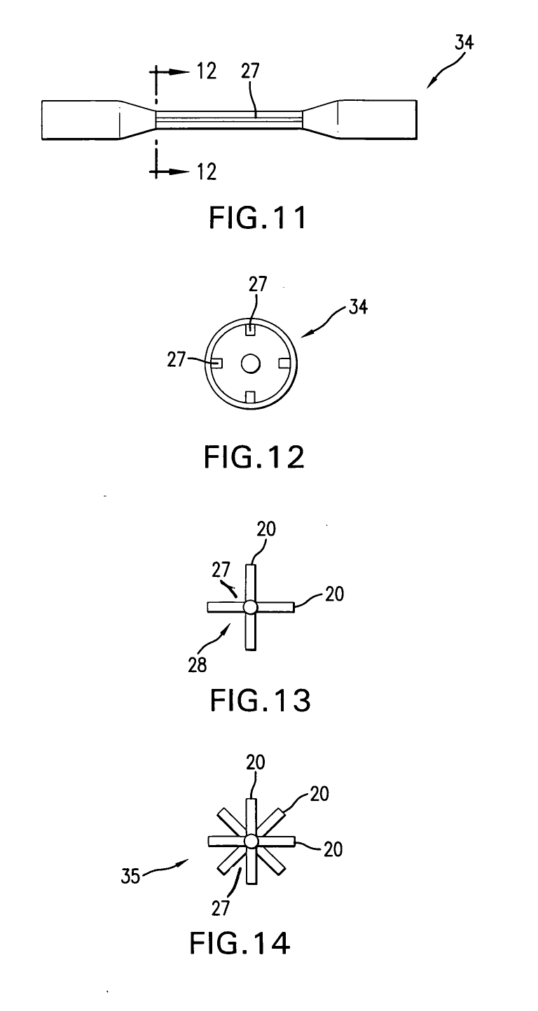

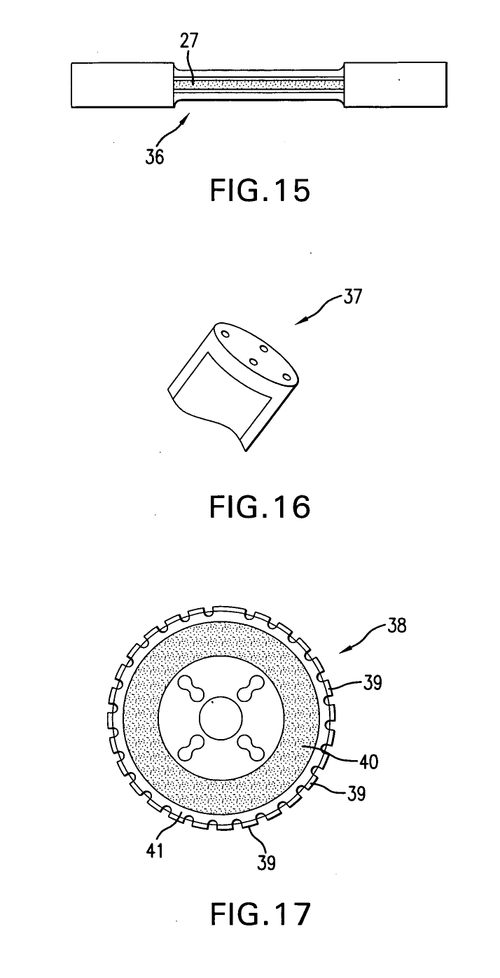

The composite is formed from a fiber reinforced curable polymer having an additive nanodiamond material 10 described infra and also shown is a first end 2, and a second end 3. In the first end 2, there is a means 4 for mounting a cutting tool (FIGS. 3, 4, and 5) which consists of an opening 5 which accommodates the means 4. The cutting tool can be adhesively mounted in the opening 5, or it can be mounted using threads, pins, screws, bolts or the like. Also, the means 4 can be mounted in the opening 5 by male screw threads 6 (shown in FIG. 4) that mate and thread into female threads 7 (FIG. 3, in phantom) in the back end 8 of the opening 5.

In the second end 3, there is shown a means for mounting an adapter (connection end) 9 that can be used to adapt to a drive means (not shown) for holding and driving the mounting means 4. Like the first end 2, the second end 3 consists of an opening 11 which accommodates the adapter 9. The adapter 9 can be adhesively mounted in the opening 11, or it can be mounted using threads, pins, screws, bolts or the like. Also, the adapter 9 can be mounted in the opening 11 by male screw threads 12 that mate and thread into female threads 13 shown in FIG. 3 in phantom in the back 14 of the opening 11.

Turning now to FIG. 5 which is a full cross sectional view of a high performance machine tool 15 of FIG. 3 through line B-B showing the Composite body 10, the cutting tool 4, and the adapter 9. Also shown in FIGS. 5 and 6 is a sheathing 16 that covers the composite body 10. The sheathing 16, for purposes of this invention can be manufactured from metal, or can be manufactured from composite materials wherein the preferred metal is steel and the preferred composite materials are fiber reinforced curable materials having fibers (or strands) such as carbon, poly-paraphenylene terephthalamide, polyvinyl alcohol, pitch fibers, pitch nanofibers, PAN and the like.

The sheathing can be compressed, locked, or threaded onto the composite body 10, or can be adhered by using adhesives, said adhesives being well-known to those skilled in the art of tool manufacture.

FIG. 6 is a full cross sectional view of the high performance machine tool 15 of FIG. 3 through line B-B wherein there is also shown a metal bar 17 in the core 18 of the body. The metal bar 17 can be compressed into the core 18, or it can be adhered to the composite body 10, in the core 18, using adhesives 20 well-known to those skilled in the art.

The diamond carbon material used in the composite of this invention and methods for manufacturing such material can be found in U.S. Pat. No. 5,916,955 that issued on Jun. 29, 1999 and U.S. Pat. No. 5,861,349 that issued on Jan. 19, 1999 to Vereschagin, et al.

The material contains carbon, hydrogen, nitrogen, oxygen and incombustible impurities of a composition specified in the specification thereof, and the material is produced by detonating an oxygen-deficient explosive in a closed volume in a medium inert towards carbon, at a cooling rate of the detonation products of 200 to 600 degrees/minute. The subject matter of those two patents are incorporated herein by reference for what they teach about the material, its production, and it properties.

The curable polymers of this invention are those that are known and commonly used in forming composites. The most popular are the epoxy resins. Standard procedures are used to manufacture the composites and such procedures are well-known to those skilled in the art, the major differences being the used of additives in the fiber reinforced curable polymer. It is contemplated within the scope of this invention to use other known fibers in conjunction with the additives of this invention as set forth infra.

“Cutting tools” for purposes of this invention are those known in the art as machine tools and include at least boring tools and face mills.

Sheathing of the body of the inventive device of this invention and the core rod of the body of this invention are preferably manufactured from steel but the invention is not limited to steel. Any material having the requisite stiffness may be used, for example tungsten carbide alloy or fiber reinforced composites. It is also contemplated within the scope of this invention to use plastic materials, such as castable and extrudable urethanes and crosslinked polyethylene and polypropylene.

The body of this invention that contains the core rod can be constructed in several different ways. For example, the cutting tool and the adapter and the core rod may be a unitary piece, or each of the tool and the adapter may be manufactured independently and matching threads in the core rod and the individual adapter and tool can be mated and screwed together. Thereafter, the composite body can be added and cured.

In another embodiment, the composite body can be manufactured around a mandrel or false core. After curing, the false core can be removed and the core rod thereafter inserted in the opening left by the false core. Thereafter, the adapter and the tool end can be mounted in the body and onto the metal rod. Using a false core is the best method to use when the composite is comprised of a film or a tape.

It is known in the art to cement the core rod to the composite body and such is the case herein. Occasionally, depending on the types of materials being used, adhesives may be used to bond the core rod and the composite body together.

Typically, the general method for manufacturing a composite-containing boring tool bar is to spin the fiber and the epoxy resin around the center core until it equals the outside diameter of the boring bar. In the instant invention, the fiber coated with the epoxy resin is pulled or drawn through an epoxy resin containing the additives and the additives adhere to the fiber as it is pulled through. Thereafter, the so-treated fiber, with the additive materials attached, is spun around the tool bar to form a winding that is later cured. In this manner, the angle of the fiber can be altered from 0 degrees angle to 90 degrees angle. Zero degrees for purposes of this method means that the fiber is laid along the longitudinal long axis of the tool bar. For purposes of this invention, 90 degrees means perpendicular to the long axis of the tool bar.

Tool bars from steel and other metals, as well as certain plastics are used as the basis for the final product. Some configurations for enhancing adhesive strength and reducing vibration in the bars can be found in the Figures.

What is claimed is:

1. A composite composition, said composition comprising:
i. a fiber reinforced curable polymer and,
ii. at least one additive material selected from the group consisting of
a. nanodiamond;
b. Buckminsterfullerene in the form of
i paper prepared from carbon nanotubes
ii balls prepared from carbon nanotubes;
c. pitch fibers;
d. pitch nanofibers;
e. polyvinyl alcohol fibers;
f. poly-paraphenylene terephthalamide having a physical form selected from the group consisting of
i films,
ii. fibers, and,
iii particulates, and,
g. PAN fibers.

2. A composite composition as claimed in claim 1 wherein the fiber for the fiber reinforced curable polymer is carbon fiber and the additive material is nanodiamond.

3. A composite composition as claimed in claim 1 wherein the fiber for the fiber reinforced curable polymer is Buckminsterfullerene and the additive material is nanodiamond.

4. A composite composition as claimed in claim 1 wherein the fiber for the fiber reinforced curable polymer is pitch fibers and the additive material is nanodiamond.

5. A composite composition as claimed in claim 1 wherein the fiber for the fiber reinforced curable polymer is pitch nanofibers and the additive material is nanodiamond.

6. A composite composition as claimed in claim 1 wherein the fiber for the fiber reinforced curable polymer is poly-paraphenylene terephthalamide and the additive material is nanodiamond.

7. A composite composition as claimed in claim 1 wherein the fiber for the fiber reinforced curable polymer is polyvinylalcohol and the additive material is nanodiamond.

8. A composite composition as claimed in claim 1 wherein the fiber for the fiber reinforced curable polymer is carbon and the additive material is Buckminsterfullerene.

9. A composite composition as claimed in claim 1 wherein the fiber for the fiber reinforced curable polymer is carbon and the additive material is Buckminsterfullerene.

10. A composite composition as claimed in claim 1 wherein the fiber for the fiber reinforced curable polymer is carbon and the additive material is pitch fibers.

11. A composite composition as claimed in claim 1 wherein the fiber for the fiber reinforced curable polymer is carbon and the additive material is pitch nanofibers.

12. A composite composition as claimed in claim 1 wherein the fiber for the fiber reinforced curable polymer is carbon and the additive material is polyvinyl alcohol.

13. A composite composition as claimed in claim 1 wherein the fiber for the fiber reinforced curable polymer is carbon and the additive material is poly-paraphenylene terephthalamide.

14. A composite composition as claimed in claim 1 wherein the fiber for the fiber reinforced curable polymer is carbon and the additive material is PAN fibers.

15. A composite tool body, said composite tool body formed from a composition comprising:
i. a fiber reinforced curable polymer and,
ii. at least one additive material selected from the group consisting of
a. nanodiamond;
b. Buckminsterfullerene in the form of
i paper prepared from carbon nanotubes
ii balls prepared from carbon nanotubes;
c. pitch fibers;
e. pitch nanofibers;
e. polyvinyl alcohol fibers;
f. poly-paraphenylene terephthalamide having a physical form selected from the group consisting of
i films,
ii. fibers, and,
iii particulates, and,
g. PAN fibers.

16. A high performance composite tool bar, said tool bar comprising:
i. a composite body having a first end and a second end, said first end being capable of having a cutting tool mounted thereon;
said second end being capable of being mounted to a driving device wherein the composite body is constructed from a fiber reinforced curable polymer further containing at least one additive material selected from the group consisting of
a. nanodiamond;
b. Buckminsterfullerene in the form of
i paper prepared from carbon nanotubes
ii balls prepared from carbon nanotubes;
c. pitch fibers;
d. pitch nanofibers;
e. polyvinyl alcohol fibers, and
f. poly-paraphenylene terephthalamide having a physical form selected from the group consisting of
i. films,
ii. fibers, and,
iii. particulates, and,
g. PAN fibers.

17. In combination, a machine tool and a composite as claimed in claim 1.

18. In combination, a contact tool and a composite as claimed in claim 1.

19. A high performance composite tool bar as claimed in claim 16 wherein the curable polymer is an epoxy resin.

20. A high performance composite tool bar as claimed in claim 16 wherein the nanodiamond material is further chemically modified.

21. A high performance composite tool bar as claimed in claim 16 wherein, additionally, there is (Kevlar) fibers present in the composite.

22. A high performance composite tool bar as claimed in claim 16 wherein the body is a solid composite.

23. A high performance composite tool bar as claimed in claim 16 wherein the body has a central metal core therein.

24. A high performance composite tool bar as claimed in claim 16 wherein the said second end is capable of being mounted to a driving device is mounted using an adapter.

25. A high performance composite tool bar as claimed in claim 16 wherein the outside surface of the composite is sheathed in a metal sheath.

26. A high performance composite tool bar as claimed in claim 25 wherein the metal sheath is steel.

27. A high performance composite tool bar as claimed in claim 16 wherein the outside surface of the composite is sheathed in a composite.

28. A nanodiamond reinforced composite body having a first end and a second end, said first end being capable of having a cutting tool mounted thereon; said second end being capable of being mounted to a driving device wherein the nanodiamond composite is constructed from
i) a diamond carbon material containing carbon, hydrogen, nitrogen, oxygen and incombustible impurities and wherein the said diamond carbon material contains at least one group selected from the group consisting of methyl groups, carboxyl groups, lactone groups, aldehyde groups, ether groups, quinone groups and combinations thereof and the composite additionally contains,
ii) a curable polymer.
